(19) United States
(12) Patent Application Publication
(10) Pub. No.: US 2005/0031845 A1
(43) Pub. Date: Feb. 10, 2005

(54) Polyester flame-retardant core for prefabricated panels and method of manufacturing the same

(76) Inventors: Myong Guk Jeong, Buk-gu (KR); Sang Min Jung, Dongnae-gu (KR)

Correspondence Address: JORDAN AND HAMBURG LLP, 122 EAST 42ND STREET, SUITE 4000, NEW YORK, NY, 10168, US

(21) Appl. No.: 10/889,737

(22) Filed: Jul. 13, 2004

(30) Foreign Application Priority Data
Aug. 7, 2003 (KR) 10-2003-0054538

(51) Int. Cl. B32B 5/22; B32B 3/26

(52) U.S. Cl. 428/304.4; 428/317.9

(57) ABSTRACT

Disclosed is a polyester flame-retardant core for prefabricated panels, which is remarkably improved in compression strength and bending strength through a foaming process of a flame-retardant material treated to polyester floss. Further, a method of manufacturing the polyester flame-retardant core, including treating polyester floss with a foamable flame-retardant material to allow the foamable flame-retardant material to be stuck between fibers of the polyester floss, followed by drying, and foaming the foamable flame-retardant material stuck between the fibers of the polyester floss by heating. The thus obtained flame-retardant core can exhibit superior compression strength and bending strength, even with a low density. Hence, the flame-retardant core can be economically manufactured and easily handled and constructed, and can improve in heat-insulating properties or weather resistance, on account of foaming properties thereof.

### BACKGROUND OF THE INVENTION

1. Field of the Invention

The present invention pertains, in general, to polyester flame-retardant cores for use in prefabricated panel (sandwiched panel) structures of industrial and commercial buildings. More specifically, the present invention is directed to a polyester flame-retardant core for prefabricated panels, which is advantageous in terms of superior compression strength and bending strength even with a low density, and a method of manufacturing the same.

2. Description of the Related Art

Generally, a prefabricated panel is made by disposing a sound-absorbing or heat-insulating core into a space between steel plates each having a thickness of an about 0.5 mm, and then attaching them to each other. As such, since the core requires structural supporting properties, it should have compression strength and bending strength higher than a predetermined level.

Such a core is exemplified by organic materials, such as polyurethane, or styrofoam, and inorganic materials, such as glass wools, or rock wools. The organic core materials can sufficiently exhibit compression strength, however, is unfavorable upon firing due to highly flammable. Hence, such organic core materials become decreasing in practical use thereof. On the other hand, although having excellent flame-retardant properties, the inorganic core materials are disadvantageous in terms of generation of dust and harmfulness to humans upon the manufacturing process. Hence, workers are reluctant to use such inorganic materials.

Mainly used as building materials in recent years, a polyester sound-absorbing and heat-insulating material is subjecting to flame-retardant treatment to be applied as the internal structure in the prefabricated panels. However, even though the flame-retardant treatment is performed through conventional techniques, the thus prepared polyester core should have a high density so as to exhibit a desired strength. In this case, the use of the polyester core having a high density leads to high manufacturing costs and difficult handling upon manufacturing and construction, and thus, becomes undesirable.

Meanwhile, the glass wool, which is applied as the internal structure in the prefabricated panel at present, is an inorganic material having a density of 48-64 kg/m³. To manufacture the prefabricated panel, the glass wool is cut at a predetermined interval, and the cut glass wool pieces are erected in parallel, and then attached between steel plates.

However, the conventional polyester core resulting from the treatment of the polyester sound-absorbing and heat-insulating material with the flame-retardant material should have a density of 70-100 kg/m³, so as to exhibit compression strength and bending strength similar to those of the glass wool.

### SUMMARY OF THE INVENTION

Leading to the present invention, the intensive and thorough research on flame-retardant cores for prefabricated panels, carried out by the present inventors aiming to avoid the problems encountered in the related art, resulted in the finding that polyester floss is treated with a foamable flame-retardant material and then such a flame-retardant material is foamed, whereby a flame-retardant core usable for structures of prefabricated panels can be manufactured to exhibit high strength even with a low density.

Therefore, it is an object of the present invention to provide a polyester flame-retardant core composed mainly of a polyester sound-absorbing and heat-insulating material, which can exhibit compression strength and bending strength similar to those of glass wools, even with a density of 70 kg/M³ or less.

Another object of the present invention is to provide a method of manufacturing such a polyester flame-retardant core.

To achieve the above objects, the present invention provides a polyester flame-retardant core for prefabricated panels, including a flame-retardant material stuck between fibers of polyester floss, wherein the flame-retardant material is in the state of being foamed.

Further, the present invention provides a method of manufacturing a polyester flame-retardant core for prefabricated panels, including treating polyester floss with a foamable flame-retardant material to allow the foamable flame-retardant material to be stuck between fibers of the polyester floss, followed by drying, and foaming the foamable flame-retardant material stuck between the fibers of the polyester floss by heating.

### DETAILED DESCRIPTION OF THE INVENTION

The present invention is characterized in that a foamable flame-retardant material is stuck between fibers of polyester floss for use in a core of a prefabricated panel and then foamed, whereby the prefabricated panel structure can increase in compression strength and bending strength.

As such, the ‘foamable flame-retardant material’ means a flame-retardant material to be foamed by heating in the dry state, which is representatively exemplified by a material composed mainly of sodium silicate. In the present invention, limitations are not imposed on the use of only the flame-retardant material composed of sodium silicate, and any flame-retardant material which is foamable by heating in the dry state may be used.

In such cases, the foaming process of the flame-retardant material by heating is preferably performed at 250° C. or less. If the foaming process to foam the flame-retardant material is carried out at temperatures higher than 250° C., the above process may occur, however, the polyester floss may be carbonized. On the other hand, a lower limit of temperature to cause the above foaming process is the temperature when the flame-retardant material begins to be foamed. The foaming degree is controlled by temperatures and times of the foaming process. It is preferred that the foaming process is sufficiently performed within the range of not causing problems of dimensional stability of the entire structure. The foaming process of the flame-retardant material is preferably conducted at 100-250° C. for 3-20 min.

Meanwhile, to foam the foamable flame-retardant material stuck between the fibers of the polyester floss, there is required, but being not limited to, a heater or heating unit heatable up to the inside of the polyester floss, or a hot air circulating-type heating chamber.

Thereby, it is possible to manufacture the flame-retardant core having a strength similar to that of glass wool by using the polyester floss with a density of about 40-70 kg/M³.

The polyester flame-retardant core, suitable for use in the prefabricated panel of the present invention, has preferably a density of 70 kg/m³ or less, and compression strength of 0.02 Mpa or more. When the compression strength is not less than 0.02 Mpa, the prefabricated panel can resist the breakage during transportation for construction, and can ensure structural support after construction.

Further, it is preferable that a density is 70 kg/m³ or less, and bending strength is not less than 0.06 Mpa. The bending strength of 0.06 Mpa or more results in breakage resistance during transportation for construction of the prefabricated panel and structural support after construction thereof.

In addition, the polyester core of the prefabricated panel, resulting from sticking the foamable flame-retardant material between the fibers of the polyester floss and then foaming it, satisfies Equations 1 and 2, below, in which the following Equations are shown as a ratio of compression strength (bending strength) to density:
Compression Strength (10³ Pa)/Density (kg/m³)≧0.40 Equation 1
Bending Strength (10³ Pa)/Density (kg/m³)≧1.0 Equation 2

A better understanding of the present invention may be obtained in light of the following examples which are set forth to illustrate, but are not to be construed to limit the present invention.

In the following Examples and Comparative Examples, compression strength and bending strength were measured according to KS M 3808 (test method of compression strength and bending strength of foamable polystyrene heat-insulating material). The results are summarized in Table 1, below.

### EXAMPLES 1 TO 12

Polyester floss having a density of 24 kg/m³ was treated with a flame-retardant material composed of 95% of liquid sodium silicate and 5% of an additive, such as aluminum oxide, aluminum hydroxide and magnesium hydroxide, and then dried, to prepare flame-retardant cores having a density of 40, 50 and 70 kg/m³, respectively. Subsequently, the prepared flame-retardant core was placed into a heating chamber and then heated to foam the flame-retardant material, according to foaming temperatures and foaming times shown in Table 1, below. The polyester floss having the foamed flame-retardant material was cut to predetermined intervals, and then the cut polyester floss pieces were erected in parallel and attached between steel plates, to manufacture test pieces, which were then measured for compression strength and bending strength. The results are shown in Table 1, below.

### COMPARATIVE EXAMPLES 1 AND 2

Glass wools each having a density of 48 and 64 kg/m³, shown in Table 1, below, were cut to the same intervals as in Examples and then the cut glass wool pieces were erected in parallel and attached between steel plates, to manufacture test pieces, which were then measured for compression strength and bending strength. The results are given in Table 1, below.

### COMPARATIVE EXAMPLES 3 AND 4

Test pieces were manufactured in the same manner as in Examples, with the except that the flame-retardant material was not foamed. Thereafter, the test pieces were measured for compression strength and bending strength. The results are given in Table 1, below.

TABLE 1

| | | Foaming | | | | | |
|---|---|---|---|---|---|---|---|
| | | Conditions | | Compress. | Bending | Compress. | Bending |
| | Density | Temp. | Time | Strength | Strength | Strength/ | Strength/ |
| No. | (kg/m³) | (° C.) | (min) | (10³ Pa) | (10³ Pa) | Density | Density |
| C. Ex. 1 | 48 | — | — | 19.2 | 55.2 | 0.40 | 1.15 |
| C. Ex. 2 | 64 | — | — | 27.4 | 91.0 | 0.42 | 1.42 |
| C. Ex. 3 | 40 | — | — | 17.4 | 32.8 | 0.43 | 0.82 |
| C. Ex. 4 | 50 | — | — | 19.5 | 39.2 | 0.39 | 0.78 |
| Ex. 1 | 40 | 200 | 5 | 23.0 | 60.0 | 0.57 | 1.50 |
| Ex. 2 | | 200 | 10 | 28.4 | 60.8 | 0.71 | 1.52 |
| Ex. 3 | 50 | 200 | 5 | 29.5 | 62.0 | 0.59 | 1.24 |
| Ex. 4 | | 200 | 10 | 33.5 | 72.6 | 0.67 | 1.45 |
| Ex. 5 | | 220 | 8 | 35.3 | 107.7 | 0.71 | 2.15 |
| Ex. 6 | 70 | 220 | 8 | 53.0 | 120.7 | 0.76 | 1.72 |
| Ex. 7 | | 150 | 5 | 36.6 | 99.2 | 0.52 | 1.41 |
| Ex. 8 | | 150 | 10 | 40.3 | 103.0 | 0.58 | 1.47 |
| Ex. 9 | | 200 | 5 | 45.6 | 95.4 | 0.65 | 1.36 |
| Ex. 10 | | 200 | 10 | 57.6 | 107.0 | 0.82 | 1.53 |
| Ex. 11 | | 250 | 5 | 46.8 | 104.2 | 0.67 | 1.49 |
| Ex. 12 | | 250 | 10 | 60.5 | 109.5 | 0.86 | 1.56 |

As apparent from Table 1, it can be confirmed that compression strength and bending strength of the flame-retardant core are fundamentally determined by the density of the core, however, can be improved according to foaming conditions even at the same density. For example, the glass wool having a density of 48 kg/m³ has a strength similar to that of the unfoamed polyester flame-retardant core having a density of 60 kg/m³ and the foamed polyester flame-retardant core having a density of 40 kg/m³ (foaming at 200° C. for 5 min or longer). Further, the glass wool having a density of 64 kg/m³ has a strength similar to that of the unfoamed polyester flame-retardant core having a density of 80-90 kg/m³ and the foamed polyester flame-retardant core having a density of 70 kg/m³ (foaming at 200° C. for 5 min or longer).

As described above, the present invention provides a polyester flame-retardant core for prefabricated panels, and a method of manufacturing the same. The polyester flame-retardant core of the present invention is advantageous in terms of superior compression strength and bending strength even with a low density. Accordingly, the inventive flame-retardant core can be economically manufactured and easily handled and constructed. In addition, the flame-retardant core of the present invention can improve in heat-insulating properties or weather resistance, by reason of foaming properties thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A polyester flame-retardant core for prefabricated panels, comprising a flame-retardant material stuck between fibers of polyester floss, wherein the flame-retardant material is in the state of being foamed.

2. The polyester flame-retardant core according to claim 1, wherein the polyester flame-retardant core has a density not more than 70 kg/m³, and compression strength not less than 0.02 Mpa.

3. The polyester flame-retardant core according to claim 1, wherein the polyester flame-retardant core has a density not more than 70 kg/m³, and bending strength not less than 0.06 Mpa.

4. The polyester flame-retardant core according to claim 1, wherein the polyester flame-retardant core satisfies Equations 1 and 2, below:
Compression Strength (10³ Pa)/Density (kg/m³)≧0.40 Equation 1
Bending Strength (10³ Pa)/Density (kg/m³)≧1.0 Equation 2

5. A method of manufacturing a polyester flame-retardant core for prefabricated panels, comprising:
treating polyester floss with a foamable flame-retardant material to allow the foamable flame-retardant material to be stuck between fibers of the polyester floss, followed by drying; and
foaming the foamable flame-retardant material stuck between the fibers of the polyester floss by heating.

6. The method according to claim 5, wherein the foaming of the foamable flame-retardant material is performed at 100-250° C. for 3-20 min.
